(19) United States
(12) Patent Application Publication
(10) Pub. No.: US 2016/0105006 A1
(43) Pub. Date: Apr. 14, 2016

(54) Shield Snipping Systems

(71) Applicant: Mark James Landes, Cheyenne, WY (US)

(72) Inventor: Mark James Landes, Cheyenne, WY (US)

(21) Appl. No.: 14/883,467

(22) Filed: Oct. 14, 2015

Related U.S. Application Data
(60) Provisional application No. 62/106,036, filed on Jan. 21, 2015.
(60) Provisional application No. 62/063,856, filed on Oct. 14, 2014.

(51) Int. Cl. H02G 1/12

(52) U.S. Cl. CPC H02G 1/1224; H02G 1/1292

(57) ABSTRACT

This invention relates to providing a system for improved wire stripping systems. More particularly this invention relates to providing a system relating to the stripping of a shield jacket of a twisted wire, especially twisted-pair wire.

### CROSS-REFERENCE TO RELATED APPLICATION

The present application is related to and claims priority from prior provisional application Ser. No. 62/063,856, filed Oct. 14, 2014, entitled “SHIELD SNIPPING SYSTEMS”; and, this application is related to and claims priority from prior provisional application Ser. No. 62/060,036, filed Jan. 21, 2015, entitled “SHIELD SNIPPING SYSTEMS”, the contents of all of which are incorporated herein by this reference and are not admitted to be prior art with respect to the present invention by the mention in this cross-reference section.

### BACKGROUND

This invention relates to providing a system for improved wire stripping. More particularly, this invention relates to providing a system relating to the stripping of a shield jacket of a twisted wire, especially twisted-pair wire.

Twisted wire (such as Mil-Spec twisted shielded pair wire) is presently used in nearly every new aircraft avionics installation. Present techniques to properly strip and prepare wire ends, for attachment to the electronics systems, are difficult and inefficient.

The difficulty in stripping a shield jacket from a twisted shielded wire arises from the intricate mesh of the shield jacket. This intricate mesh is constructed as a fine braided mesh of very small strands. Therefore, presently this shield jacket is removed by snipping the mesh a small number of strands at a time all the way around the wire. As a result, a large number of these very fine, tiny pieces of strands can fall around the area in which the user is working. This can become a problem when these small fragments of mesh are falling inside the intricate components of an airplane. Furthermore, removal of the shield jacket from a shielded wire can result in the inner conductors being nicked by a blade, with the area affected becoming a likely point of cable failure. Over time, such a failure can result in an intermittent ground fault.

### OBJECTS AND FEATURES OF THE INVENTION

A primary object and feature of the present invention is to provide a system overcoming the above-mentioned problems.

It is a further object and feature of the present invention to provide such a system capable of cutting at least one segment of a braided shield in a shielded wire while protecting at least one inner conductor of the shielded wire from scoring and cutting.

It is a further object and feature of the present invention to provide such a system to remove the shielding of a twisted wire in a uniform manner without dropping small fragments of the shield around or inside a component.

A further object and feature of the present invention is to provide such a system that is manually actuated without the need for electrical motivation or control.

A further object and feature of the present invention is to provide a system incorporating multiple die-mandrel sets for processing twisted shielded wire varying sizes.

A further object and feature of the present invention is to provide such a system wherein the cutting means for cutting the shielding is user replaceable/renewable.

A further primary object and feature of the present invention is to provide such a system that is efficient, inexpensive, and handy. Other objects and features of this invention will become apparent with reference to the following descriptions.

### SUMMARY OF THE INVENTION

A system, relating to cutting at least one segment of a braided shield in a shielded wire while protecting at least one inner conductor of the shielded wire from scoring and cutting, comprising: cutting means for cutting the at least one segment of the braided shield in the shielded wire; shield-positioner means for positioning and retaining the braided shield within at least one cutting area of such cutting means during such cutting; and conductor-positioner means for positioning and retaining the at least one inner conductor of the shielded wire outside of such at least one cutting area of such cutting means during such cutting; wherein such shield-positioner means and such conductor-positioner means comprise interposer means for interposing between the braided shield and the at least one inner conductor; and wherein, during such cutting of the braided shield, the at least one inner conductor of the shielded wire is protected from scoring and cutting by such cutting means. Moreover, it provides such a system further comprising cutter-positioner means for movably positioning such cutting means between at least one non-cutting position and at least one cutting position enabling cutting of the at least one segment of the braided shield. Additionally, it provides such a system wherein such cutter-positioner means comprises cutter retainer means for removably retaining such cutting means thereon.

Also, it provides such a system further comprising supportive coupling means for supportively coupling such cutter-positioner means, such shield-positioner means, and such conductor-positioner means. In addition, it provides such a system wherein such cutter-positioner means comprises manual actuation means for assisting manual actuation of such cutter-positioner means without the need for electrical motivation or control. And, it provides such a system wherein such supportive coupling means comprises hand gripping means for assisting hand gripping of such supportive coupling means. Further, it provides such a system wherein such interposer means comprises releasable coupler means for releasably coupling such interposer means with such supportive coupling means.

In accordance with another preferred embodiment hereof, this invention provides a system, relating to cutting at least one segment of a braided shield in a shielded wire while protecting at least one inner conductor of the shielded wire from scoring and cutting, comprising: at least one cutter structured and arranged to cut the at least one segment of the braided shield in the shielded wire; at least one shield-positioner structured and arranged to position and retain the braided shield within at least one cutting area of such cutter during cutting; and at least one conductor-positioner structured and arranged to position and retain the at least one inner conductor of the shielded wire outside of such at least one cutting area of such cutter during cutting; wherein such at least one shield-positioner and such at least one conductor-positioner comprise at least one interposer structured and arranged to interpose between the braided shield and the at least one inner conductor; and wherein, during cutting of the braided shield, the at least one inner conductor of the shielded wire is protected by such interposer from scoring and cutting by such cutter.

Moreover, it provides such a system further comprising at least one actuator structured and arranged to actuate such at least one cutter from at least one non-cutting position to at least one cutting position. Additionally, it provides such a system wherein such at least one interposer comprises at least one releasable coupler structured and arranged to releasably couple such at least one interposer with such system. Also, it provides such a system wherein such at least one cutter comprises at least one releasable coupler structured and arranged to releasably couple such at least one cutter with such system.

In addition, it provides such a system Further comprising: at least one cut-length setter structured and arranged to set a cut length of such at least one segment of the braided shield; wherein such at least one cut-length setter comprises at least one impingement rod adjustably positioned within such at least one conductor-positioner, and at least one collet nut adapted to adjustably retain such at least one impingement rod at a selected position within such at least one conductor-positioner; and wherein such at least one impingement rod controls the length of the at least one inner conductor that can be inserted within such at least one conductor-positioner by impingement with the at least one inner conductor.

And, it provides such a system wherein such at least one cutting comprises at least two cutting blades; at least one blade guide structured and arranged to guide such at least two blades from at least one open position to at least one cutting position; at least one actuator engager structured and arranged to engage such at least one actuator and such at least two cutting blades; at least one cutter enclosure structured and arranged to enclose such at least one cutter. Further, it provides such a system wherein such at least one actuator engager comprises at least one bearing.

In accordance with another preferred embodiment hereof, this invention provides a system, relating to cutting at least one segment of a braided shield in a shielded wire while protecting at least one inner conductor of the shielded wire from scoring and cutting, comprising: at least two cutting blades structured and arranged to circumferentially cut off the at least one segment of the braided shield; and at least one mandrel structured and arranged to interpose between the braided shield and the at least one inner conductor; wherein such at least one mandrel comprises at least one outer surface having an outer perimeter and at least one inner surface having an inner cross-sectional area; wherein such inner cross-sectional area of such at least one inner surface comprises a size sufficient to contain the at least one inner conductor; wherein such at least two cutting blades comprise a blade edge substantially matching such outer perimeter of such at least one outer surface; wherein such at least two cutting blades and such at least one outer surface comprise at least one circular anvil-cutter structured and arranged to cut material between such at least two cutting blades and such at least one outer surface; and wherein such at least one inner surface prevents the at least one inner conductor from positioning between such at least two cutting blades and such at least one outer surface while such at least one outer surface positions the braided shield between such at least two cutting blades and such at least one outer surface.

Even further, it provides such a system further comprising at least two movable armatures each one structured and arranged to moveably support at least one cutting blade of such at least two cutting blades; wherein such at least two movable armatures are configured to assist in moving such at least two cutting blades from at least one non-cutting position to at least one cutting position enabling cutting of the material located between such at least two cutting blades and such at least one outer surface. Moreover, it provides such a system wherein each one of such at least two movable armatures comprise at least one blade retainer structured and arranged to removably retain such at least one cutting blade thereon.

Additionally, it provides such a system wherein such blade retainer comprises at least one quick-release assembly structured and arranged to assist manual quick release of such at least one cutting blade without the use of tools. Also, it provides such a system wherein such at least two cutting blades are of substantially identical physical geometry. In addition, it provides such a system further comprising at least one support frame structured and arranged to support such at least two movable armatures and such at least one mandrel. And, it provides such a system further comprising at least one manual actuator structured and arranged to assist manual actuation of such at least two movable armatures without the need for electrical motivation or control. Further, it provides such a system wherein such at least one manual actuator comprises at least one hand grip structured and arranged to assist hand gripping of such at least one manual actuator.

Even further, it provides such a system wherein each such at least two movable armatures comprises at least one pivot axis about which a respective one of such at least two movable armatures rotate; and at least one rotation coordinator structured and arranged to coordinate a cotemporaneous rotation of such at least two movable armatures between at least one non-cutting position and such at least one cutting position enabling material between such at least two cutting blades and such at least one outer surface to be cut.

Moreover, it provides such a system wherein such at least one support frame further comprises at least one mandrel coupler structured and arranged to releasably couple such at least one mandrel thereon. Additionally, it provides such a system wherein such at least one mandrel coupler comprises at least one quick-release coupler structured and arranged to assist manual quick release of such at least one mandrel coupler without the use of tools. Also, it provides such a system wherein such at least one mandrel comprises at least one tubular member comprising at least one hollow interior portion; and such at least one hollow interior portion is adapted to accommodate the at least one inner conductor of the shielded wire.

In addition, it provides such a system further comprising at least one cut-length setter structured and arranged to assist setting a cut length of such at least one segment of the braided shield; wherein such at least one cut-length setter comprises at least one impingement rod adjustably positioned within such at least one hollow interior portion, and at least one collet nut adapted to adjustably retain such at least one impingement rod at a selected position within such at least one hollow interior portion; wherein such at least one support frame comprises at least one threaded end adapted to threadably receive such at least one collet nut; and wherein such at least one impingement rod controls the length of the at least one inner conductor that can be inserted within such at least one hollow interior portion by impingement with the at least one inner conductor.

In accordance with another preferred embodiment hereof, this invention provides a system, relating to cutting segments of variously-sized braided shields in variously-sized shielded wires while protecting inner conductors of the variously-sized shielded wires from scoring and cutting, such system comprising at least two first-sized cutting blades structured and arranged to circumferentially cut off at least one first-size segment of a first-size braided shield; at least one first-size mandrel structured and arranged to interpose between the first-size braided shield and first-size inner conductors of the first-size braided shield; at least two second-sized cutting blades structured and arranged to circumferentially cut off at least one second-size segment of a second-size braided shield; at least one second-size mandrel structured and arranged to interpose between the second-size braided shield and the second-size inner conductors of the second-size braided shield; wherein such at least one first-size mandrel comprises at least one first-size outer surface having a first-size outer perimeter and at least one first-size inner surface having a first-size inner cross-sectional area; wherein such first-size inner cross-sectional area of such first-size at least one inner surface comprises a first-size sufficient to contain the at least one first-size inner conductor; wherein each such at least two first-size cutting blades comprise a first-size blade edge substantially matching such first-size outer perimeter of such at least one first-size outer surface; wherein such at least two first-size cutting blades and such at least one first-size outer surface comprise at least one first-size circular anvil-cutter structured and arranged to cut material between such at least two first-size cutting blades and such at least one first-size outer surface; wherein such at least one first-size inner surface prevents the at least one first-size inner conductor from positioning between such at least two first-size cutting blades and such at least one first-size outer surface while such at least one first-size outer surface positions the first-size braided shield between such at least two first-size cutting blades and such at least one first-size outer surface; wherein such at least one second-size mandrel comprises at least one second-size outer surface having a second-size outer perimeter and at least one second-size inner surface having a second-size inner cross-sectional area; wherein such second-size inner cross-sectional area of such second-size at least one inner surface comprises a first-size sufficient to contain the at least one second-size inner conductor; wherein such at least two second-size cutting blades comprise a second-size blade edge substantially matching such second-size outer perimeter of such at least one second-size outer surface; wherein such at least two second-size cutting blades and such at least one second-size outer surface comprise at least one second-size circular anvil-cutter structured and arranged to cut material between such at least two second-size cutting blades and such at least one second-size outer surface; wherein such at least one second-size inner surface prevents the at least one second-size inner conductor from positioning between such at least two second-size cutting blades and such at least one second-size outer surface while such at least one second-size outer surface positions the second-size braided shield between such at least two second-size cutting blades and such at least one second-size outer surface; and at least one wire stripper device structured and arranged to interchangeably utilize such at least one first-size mandrel, such at least one second-size mandrel, such at least two first-size cutting blades, and such at least two second-size cutting blades. According to preferred embodiments of the present invention this invention provides each and every novel feature, element, combination, step and/or method disclosed or suggested by this patent application.

### BRIEF DESCRIPTION OF THE DRAWINGS

FIG. 1 shows a perspective view, illustrating an improved wire stripper, according to a preferred embodiment of the present invention.

FIG. 2 shows a cut-away perspective view, illustrating an example electrically-conductive wire having a braided metal shield jacket.

FIG. 3 shows a perspective view, partially exploded for clarity, illustrating a cutting assembly of the wire stripper, according to the preferred embodiment of FIG. 1.

FIG. 4 shows a detail view, enlarged for clarity, depicting a cutting die set and tubular-shaped mandrel of the cutting assembly, according to the preferred embodiment of FIG. 1.

FIG. 5 shows a perspective view, illustrating the cutting die set of the cutting assembly of FIG. 2 moved to a closed cutting position, according to the preferred embodiment of FIG. 1.

FIG. 6 shows a diagrammatic side view, illustrating the end portion of the shielded wire arranged in proximity of the mandrel and the cutting die set of the cutting assembly.

FIG. 7 shows a second diagrammatic side view, illustrating an end portion of a shielded wire engaged on the mandrel and placed in proximity of the cutting die set.

FIG. 8 shows a diagrammatic sectional view, through the section 8-8 of FIG. 7, illustrating the end portion of the shielded wire engaged on the mandrel and placed in proximity of the cutting die set.

FIG. 9 shows a third diagrammatic side view, illustrating the end portion of the shielded wire engaged on the mandrel with the cutting die set moved to a position enabling the cutting of the braided shield.

FIG. 10 shows a diagrammatic sectional view, through the section 10-10 of FIG. 9, illustrating cutting die set forming a circumferential cut through the braided shield.

FIG. 11 shows a fourth diagrammatic side view, illustrating the cutting die set moved to a non-cutting position enabling the separation of the end portion of the shielded wire from the mandrel and removal of a cut segment of the braided shield.

FIG. 12 shows a perspective view, exploded for clarity, illustrating components of a movable armature, cutting die, and manual quick-release feature of the cutting assembly, according to the preferred embodiment of FIG. 1.

FIG. 13 shows a diagrammatic sectional view, through the section 13-13 of FIG. 1, illustrating the wire stripper, according to the preferred embodiment of FIG. 1.

FIG. 14 shows a perspective view, illustrating the removable mandrel separated from the wire stripper, according to the preferred embodiment of FIG. 1.

FIG. 15 shows a side view, in partial section, illustrating an adjustment feature of a cut-length gauge of the cutting assembly, according to the preferred embodiment of FIG. 1.

FIG. 16 shows a perspective view, exploded for clarity, illustrating components of the wire stripper, according to the preferred embodiment of FIG. 1.

FIG. 17 shows a diagram illustrating interchangeable components of the wire stripper, according to the preferred embodiment of FIG. 1.

FIG. 18 shows a perspective view, illustrating another improved wire stripper, according to another preferred embodiment of the present invention.

FIG. 19 shows a perspective view, partially exploded for clarity, illustrating a die cartridge of the wire stripper, according to the preferred embodiment of FIG. 18.

FIG. 20 shows a side view, illustrating the wire stripper, according to the preferred embodiment of FIG. 18.

FIG. 21 shows a top view, illustrating the wire stripper, according to the preferred embodiment of FIG. 18.

FIG. 22 shows a diagrammatic sectional view, through the section 22-22 of FIG. 21, illustrating the wire stripper, according to the preferred embodiment of FIG. 18.

FIG. 23 shows a cutaway view, illustrating armature motion of the wire stripper, according to the preferred embodiment of FIG. 18.

FIG. 24 shows a partial-exploded perspective view, illustrating a cutting assembly of the wire stripper, according to the preferred embodiment of FIG. 18.

FIG. 25 shows a detail perspective view, illustrating a quick release of the wire stripper, according to the preferred embodiment of FIG. 18.

FIG. 26 shows a cross-sectional detail view, illustrating a quick release of the wire stripper, according to the preferred embodiment of FIG. 18.

FIG. 27 shows an exploded perspective view, illustrating the die cartridge of the wire stripper, according to the preferred embodiment of FIG. 18.

FIG. 28 shows a perspective view, illustrating the die cartridge of the wire stripper, according to the preferred embodiment of FIG. 18.

FIG. 29 shows a diagrammatic sectional view, through the section 29-29 of FIG. 28, illustrating the die cartridge of the wire stripper, according to the preferred embodiment of FIG. 18.

FIG. 30 shows a diagrammatic sectional view, through the section 30-30 of FIG. 19, illustrating the die cartridge of the wire stripper, according to the preferred embodiment of FIG. 18.

### DETAILED DESCRIPTION OF THE BEST MODES AND PREFERRED EMBODIMENTS OF THE INVENTION

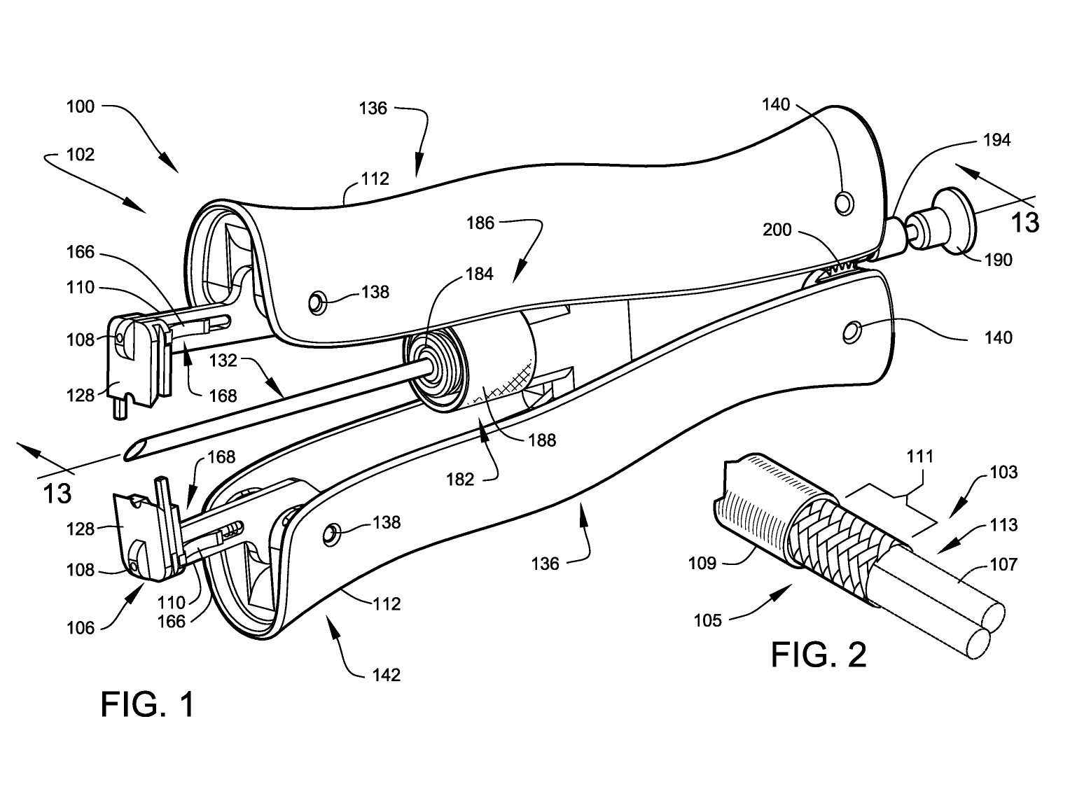

FIG. 1 shows a perspective view, illustrating an improved wire stripper 102, according to one preferred embodiment of the present invention. FIG. 2 shows a cut-away perspective view, illustrating an electrically-conductive shielded wire 103 of a type that the preferred embodiments of the present invention are designed to modify. More specifically, preferred system embodiments are preferably configured to strip away the braided shield jacket 105 of a twisted wire, especially twisted-pair wire. Such twisted-pair wire (such as, for example, Mil-Spec shielded twisted-pair wire) is presently incorporated within nearly every new aircraft avionics installation. Wire stripper 102 is preferably designed to service a majority of multi-conductor cables used in aviation-related electronics installations.

The present invention, generally identified herein as wire stripper system 100, preferably comprises a range of useful wire-stripping embodiments, each one designed to selectively remove at least an end segment 111 of the braided shield jacket 105 of shielded wire 103 without damaging the inner conductors 107 of the wire.

Referring to the illustration of FIG. 1, wire stripper 102 preferably comprises a hand-held apparatus having two outer gripping surfaces 112 surrounding an inner cutting assembly 106, as shown. Wire stripper 102 preferably comprises a physical configuration that permits the apparatus to be comfortably held by the hand of an adult operator during use. As will be described in greater detail below, the operation of wire stripper 102 is fully manual, requiring no pneumatic or electrically actuated componentry (at least herein embodying wherein such cutter-positioner means comprises manual actuation means for assisting manual actuation of such cutter-positioner means without the need for electrical motivation or control; and, at least embodying herein at least one manual actuator structured and arranged to assist manual actuation of such at least two movable armatures without the need for electrical motivation or control).

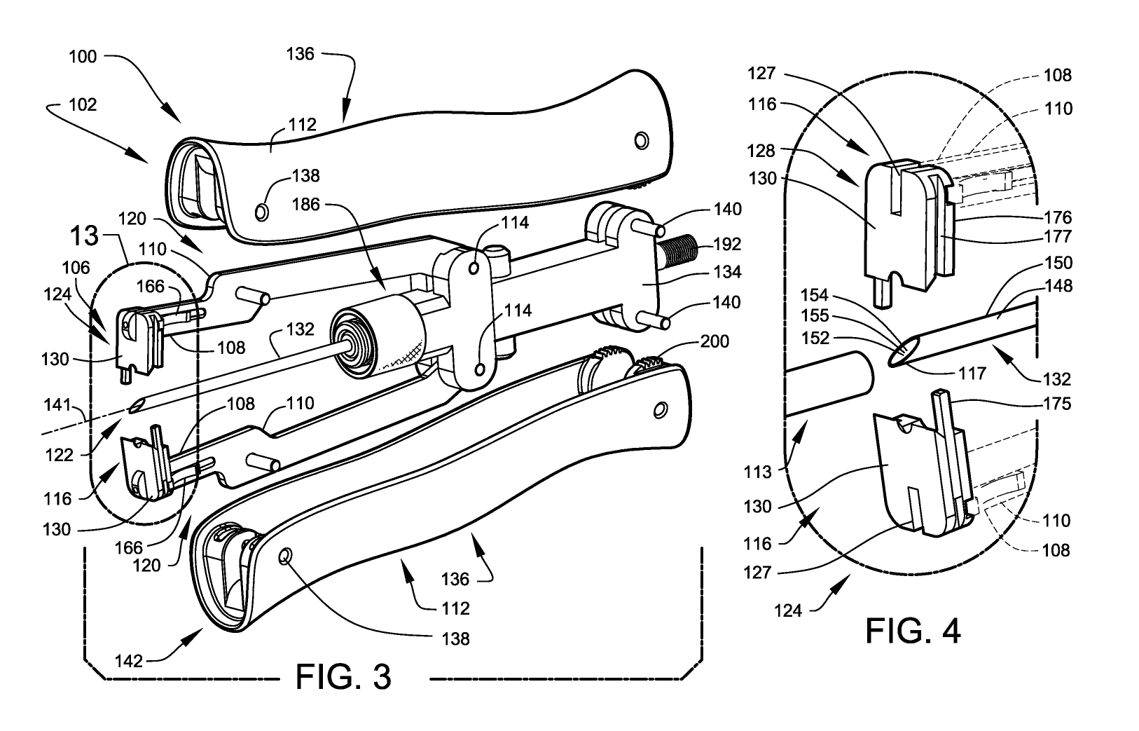

FIG. 3 shows a perspective view, partially exploded for clarity, illustrating inner cutting assembly 106 of wire stripper 102, according to the preferred embodiment of FIG. 1. Inner cutting assembly 106 preferably comprises at least one armature assembly 120, at least one mandrel assembly 122, at least one die assembly 124, and at least one central support frame 134. Armature assembly 120 preferably comprises at least one armature 110. Mandrel assembly 122 preferably comprises at least one tubular-shaped mandrel 132. Die assembly 124 preferably comprises at least one cutting die set 116. FIG. 4 shows a detail view, enlarged for clarity, depicting cutting die set 116 and tubular-shaped mandrel 132 of cutting assembly 106, according to the preferred embodiment of FIG. 1. In the illustration of FIG. 3, the outer handgrips 136 (comprising gripping surfaces 112) have been separated from the apparatus to more clearly depict the preferred configuration of the inner cutting assembly 106.

Armature assembly 120 preferably comprises two moveable armatures 110 symmetrically located in opposing positions about tubular-shaped mandrel 132, as shown (at least embodying herein at least two movable armatures each one structured and arranged to moveably support at least one cutting blade of such at least two cutting blades). Central support frame 134 is preferably provided to support the two movable armatures 110 and mandrel 132 in a preferred operable geometrical relationship, as shown (at least embodying herein at least one support frame structured and arranged to support such at least two movable armatures and such at least one mandrel). Both central support frame 134 and mandrel 132 are located along longitudinal axis 141, as shown.

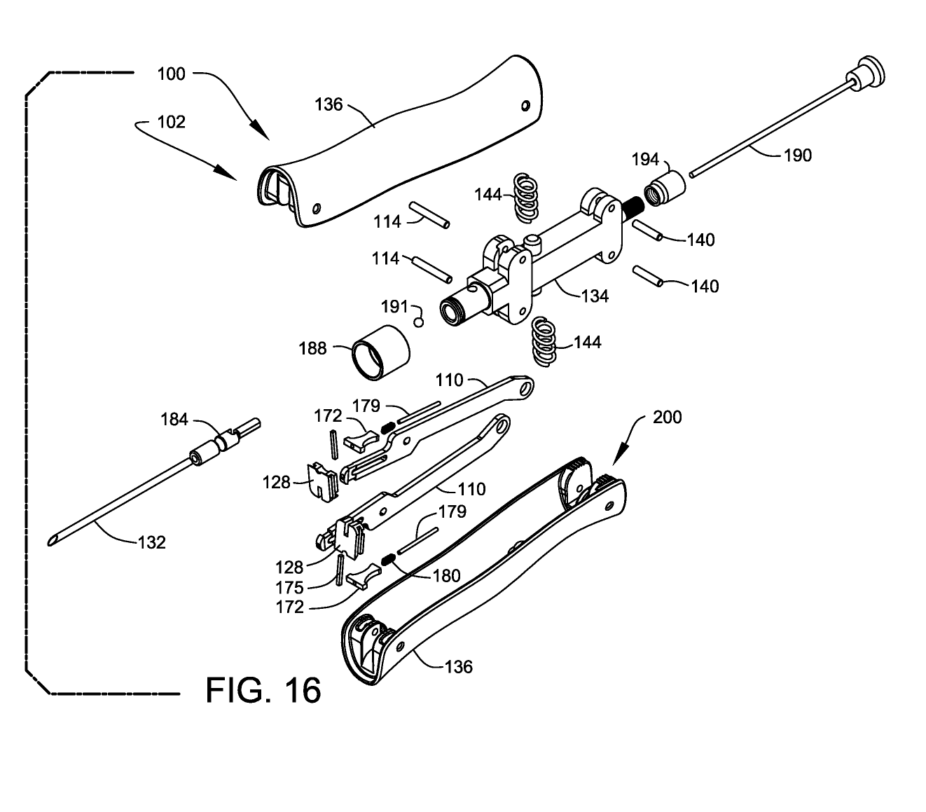

Preferably, both of the two moveable armatures 110 are pivotally coupled to central support frame 134 (at least embodying herein further comprising supportive coupling means for supportively coupling such cutter-positioner means, such shield-positioner means, and such conductor-positioner means). More particularly, armatures 110 are pivotally coupled to support frame 134 by a set of rear armature pivots 114 (at least embodying herein each such at least two movable armatures comprises at least one pivot axis about which a respective one of such at least two movable armatures rotate), which are preferably oriented perpendicularly to longitudinal axis 141, as shown (see also FIG. 16).

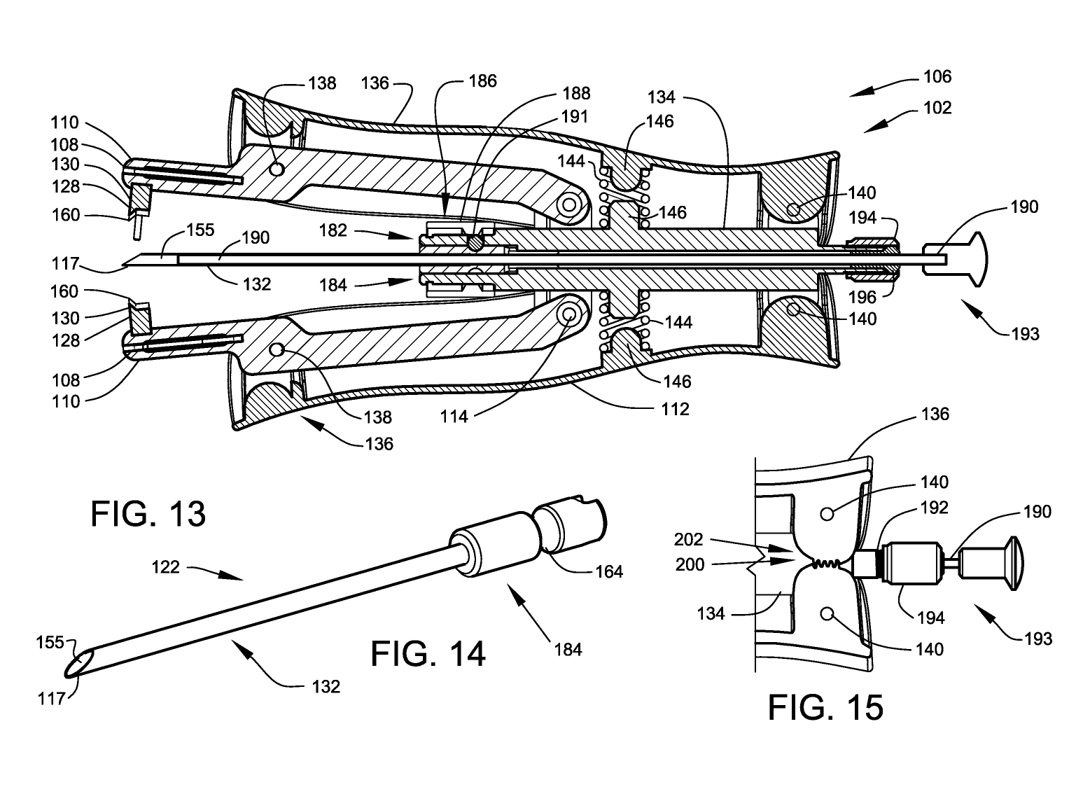

When assembled, each movable armature 110 preferably resides within the hollow inner shell of a respective handgrip 136 (see also FIG. 1). Preferably, each handgrip 136 (at least herein embodying wherein such supportive coupling means comprises hand gripping means for assisting hand gripping of such supportive coupling means) is connected to a respective moveable armature 110 by a forward armature pivot 138 and to support frame 134 by a rear handgrip pivot 140, as shown. Preferably, both handgrips 136, along with the movable armatures 110 to which they are coupled, are biased to an open (non-cutting) configuration 142 (see FIG. 1) by set of biasing springs 144 (preferably helical springs) operating between handgrips 136 and support frame 134, as best shown in FIG. 13.

Referring to FIG. 4, with continued reference to FIG. 3, the distal ends 108 of armatures 110 preferably support cutting die set 116. More specifically, the distal ends 108 of the armatures are each fitted with a cutting die half-portion 128, as shown (at least embodying herein cutting means for cutting the at least one segment of the braided shield in the shielded wire). The two cutting die half-portions 128 (at least embodying herein at least two cutting blades structured and arranged to circumferentially cut off the at least one segment of the braided shield) preferably combine to form cutting die set 116.

Each cutting die half-portion 128 is constructed of a rigid material, most preferably a metallic material. Each cutting die half-portion 128 (also identified herein as metal die 130) is preferably configured to allow the same metal die 130 to be installed interchangeably on either of the two movable armatures 110. Preferably, each metal die 130 comprises an identical physical configuration, preferably including a symmetrical mounting configuration to allow such preferred interchangeably between either of the two movable armatures 110 (at least herein embodying wherein such at least two cutting blades are of substantially identical physical geometry).

Mandrel 132 preferably comprises an elongated cylindrical tube having an outer surface 148 with an outer perimeter 150 and a hollow inner bore 155 having an inner surface 152 and inner cross-sectional area 154. The end termination of mandrel 132 preferably comprises a point bevel 117 having an angle of about 45°, as shown. Mandrel 132 is preferably constructed from at least one rigid material with a single rigid metallic material being most preferred.

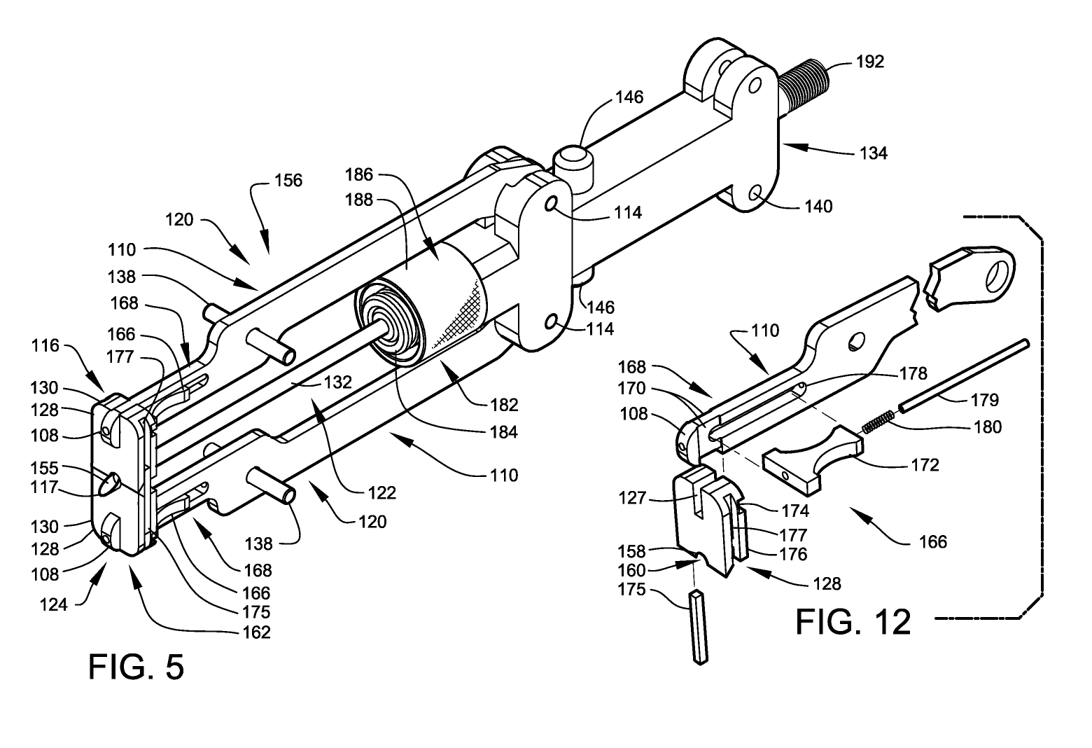

FIG. 5 shows a perspective view, illustrating cutting assembly 106 with cutting die set 116 moved from the open (non-cutting) configuration 142 of FIG. 2 to a closed (cutting) configuration 156, according to the preferred embodiment of FIG. 1. In the closed (cutting) configuration 156, cutting die half-portions 128 are moved into contact with the rigid outer surface 148 of mandrel 132, as shown. The closed (cutting) configuration 156 is preferably achieved by applying a squeezing force to both handgrips 136 (see FIG. 1 and FIG. 3) while grasping the apparatus (at least herein embodying wherein such at least one manual actuator comprises at least one hand grip structured and arranged to assist hand gripping of such at least one manual actuator). This action rotates handgrips 136 about rear handgrip pivots 140 toward longitudinal axis 141. As each armature 110 is coupled to a respective handgrip 136 by a respective forward armature pivot 138, both armatures 110 (at least embodying herein cutter-positioner means for movably positioning such cutting means between at least one non-cutting position and at least one cutting position enabling cutting of the at least one segment of the braided shield; and, at least herein embodying wherein such at least two movable armatures are configured to assist in moving such at least two cutting blades from at least one non-cutting position to at least one cutting position enabling cutting of the material located between such at least two cutting blades and such at least one outer surface) rotate along with the handgrips in the direction of longitudinal axis 141. The preferred action brings both cutting die half-portions 128 into positions of contact with outer surface 148 of mandrel 132, as shown.

Each metal die 130 preferably contains at least one cutting blade 158 having at least one arcuate-shaped blade edge 160 (see also FIG. 8). The inner diameter of the arcuate-shaped blade edge 160 is preferably size matched to the outer perimeter 150 of outer surface 148. Furthermore, the inner diameter of the arcuate-shaped blade edge 160 and outer perimeter 150 of outer surface 148 are preferably size matched to the shielded wire to be stripped.

Mandrel 132, when connected to support frame 134, comprises a preferred length that extends slightly beyond the arcuate-shaped blade edges 160 when the assembly is positioned in the closed (cutting) configuration 156. This preferred arrangement allows the rigid outer surface 148 of mandrel 132 to function in an anvil-like manner by supporting and positionally restraining the material to be cut. This preferred arrangement allows a majority of the manual force applied at the handgrips 136 to be transferred through the arcuate-shaped blade edges 160 to the material to be cut. In this manner, the two cutting blades 158 of cutting die half-portions 128 and the rigid outer surface 148 of mandrel 132 together form a circular anvil-cutter 162 structured and arranged to cut material positioned between cutting blades 158 and such outer surface 148 (at least herein embodying wherein such at least two cutting blades and such at least one outer surface comprise at least one circular anvil-cutter structured and arranged to cut material between such at least two cutting blades and such at least one outer surface).

Preferably, each metal die 130 comprises lateral tab 175 and lateral socket 177, as shown. Preferably, lateral tab 175 and lateral socket 177 preferably function to positionally interlock and laterally support the two metal dies 130 during a cutting procedure. Preferably, when lateral tab 175 and lateral socket 177 are inter-engaged, the resulting circular anvil-cutter 162 operates as a substantially unitary element.

FIG. 6 through FIG. 11 depict a sequence of preferred steps relating the preferred use of wire stripper 102 to remove an end segment of braided shield jacket 105 from shielded wire 103.

FIG. 6 shows a diagrammatic side view, illustrating end portion 113 of shielded wire 103 arranged in proximity of mandrel 132 and cutting die set 116 of cutting assembly 106. In FIG. 6, cutting die set 116 is arranged in the open (non-cutting) configuration 142. It should be noted that the diagrammatic depictions of FIG. 6 through FIG. 11 show only the above-noted structures of cutting assembly 106, for clarity of description.

In an initial preferred preparation step, an end segment 111 of braided shield jacket 105 is exposed by removing an end portion of outer protective sheath 109 from shielded wire 103 using a different apparatus. It is further noted that, depending on the composition of the shielded wire to be stripped and the available spacing between the conductors and the shielding, applicant's device can be used to cut both outer protective sheath 109 and braided shield jacket 105 in a single step.

Next, braided shield jacket 105 is pushed back slightly to expose inner conductors 107. Preferably, the tubular-shaped mandrel 132 is guided over the inner conductors 107 of shielded wire 103 thereby positioning inner conductors 107 within inner bore 155, as shown (at least herein embodying wherein such at least one mandrel comprises at least one tubular member comprising at least one hollow interior portion; and such at least one hollow interior portion is adapted to accommodate the at least one inner conductor of the shielded wire). An impingement rod 190, located within inner bore 155 (see also FIG. 8), limits the length of inner conductors 107 that can be inserted into inner bore 155. The preferred use of impingement rod 190 is described in greater detail in FIG. 14. Braided shield jacket 105 is then slid forward over outer surface 148 of mandrel 132 until it is stretched back to roughly its original position relative to inner conductors 107 to achieve the configuration.

FIG. 7 shows a second diagrammatic side view, illustrating mandrel 132 engaged with the end portion of shielded wire 103 and placed in proximity of cutting die set 116. FIG. 8 shows a diagrammatic sectional view, through the section 8-8 of FIG. 7, illustrating the preferred positioning of mandrel 132 relative to the components of shielded wire 103. In FIG. 7, cutting die set 116 remains in the open (non-cutting) configuration 142.

FIG. 7 and FIG. 8 illustrate the preferred pre-cut positioning of inner conductors 107 located within the hollow inner bore 155 of mandrel 132 and the preferred positioning of braided shield jacket 105 adjacent outer surface 148 of mandrel 132. Mandrel 132 preferably comprises an outer diameter D1, which is slightly larger than that of inner conductors 107 (as a whole) of the wire to be cut. Inner bore 155 preferably comprises an inner cross-sectional area 154 sufficient to contain all inner conductors 107 of shielded wire 103 (at least herein embodying wherein such inner cross-sectional area of such at least one inner surface comprises a size sufficient to contain the at least one inner conductor).

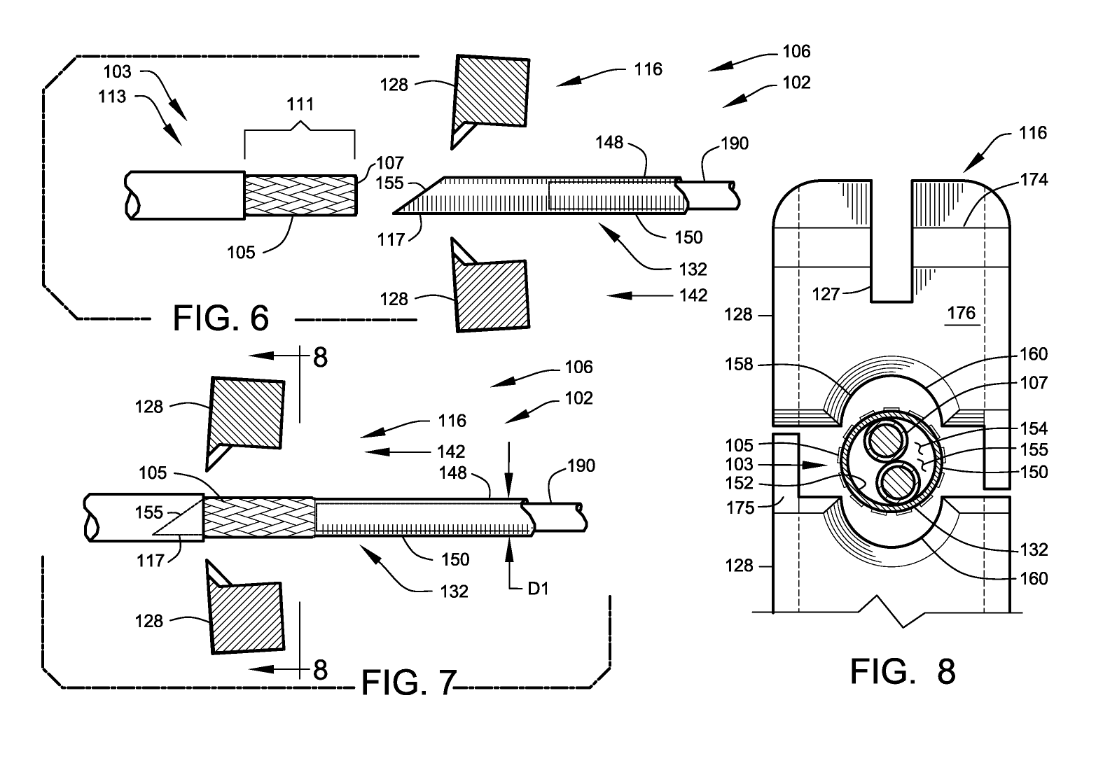

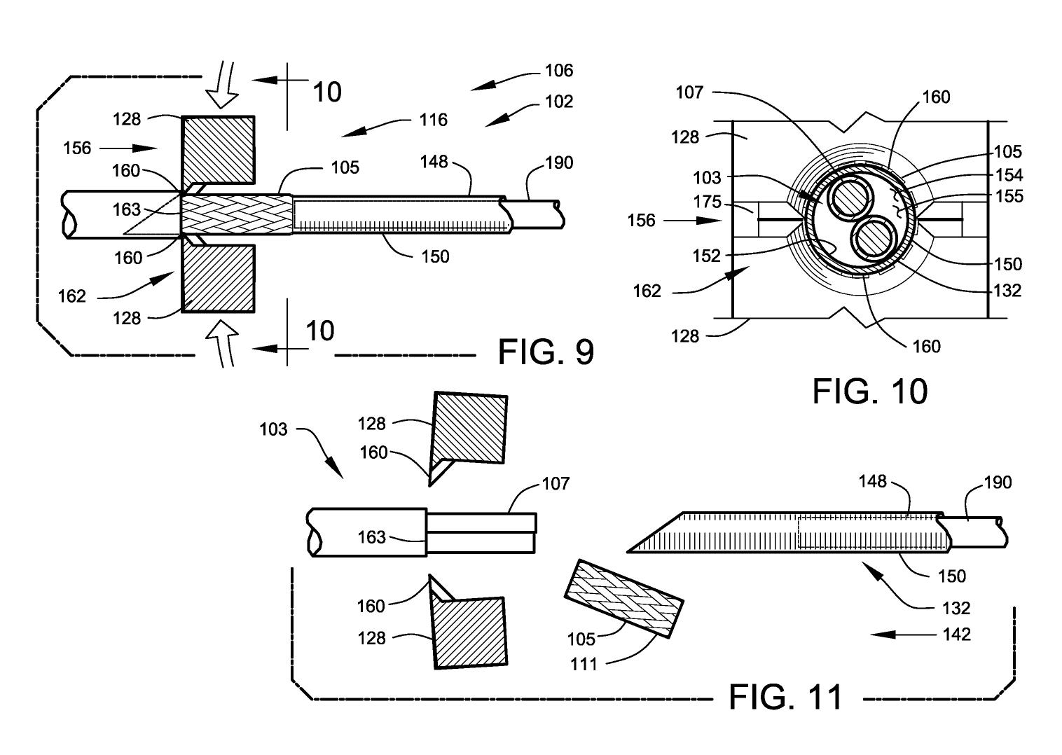

FIG. 9 shows a third diagrammatic side view, illustrating the end portion of shielded wire 103 engaged on mandrel 132 with cutting die set 116 moved from the open (non-cutting) configuration 142 to a closed (cutting) configuration 156. FIG. 10 shows a diagrammatic sectional view, through the section 10-10 of FIG. 9, illustrating cutting die set 116 forming a circumferential cut 163 through the braided shield.

To create a cut (allowing the braided shield jacket 105 to be removed from shielded wire 103), the user squeezes handgrips 136 to bring the arcuate-shaped blade edges 160 of cutting die half-portions 128 in contact with outer surface 148 of mandrel 132.

Preferably, each arcuate-shaped blade edge 160 comprises a blade shape substantially matching outer perimeter 150 of outer surface 148, as shown (at least herein embodying wherein such at least two cutting blades comprise a blade edge substantially matching such outer perimeter of such at least one outer surface. As the two cutting die portions come together around mandrel 132, braided shield jacket 105 is cut circumferentially around mandrel 132. The tubular-shaped mandrel 132 is preferably configured to interpose between braided shield jacket 105 and the inner conductors 107 during a cutting procedure (at least herein embodying wherein such shield-positioner means and such conductor-positioner means comprise interposer means for interposing between the braided shield and the at least one inner conductor; and, at least embodying herein at least one mandrel structured and arranged to interpose between the braided shield and the at least one inner conductor). Thus, mandrel 132 preferably functions as a protective barrier between inner conductors 107 and cutting blades 158 during a cutting procedure to prevent scoring and cutting of the conductors (at least embodying herein wherein, during such cutting of the braided shield, the at least one inner conductor of the shielded wire is protected from scoring and cutting by such cutting means). Inner surface 152 of inner bore 155 (at least embodying herein conductor-positioner means for positioning and retaining the at least one inner conductor of the shielded wire outside of such at least one cutting area of such cutting means during such cutting) preferably prevents inner conductors 107 from being positioned between the cutting blades and outer surface 148 while outer surface 148 (such outer surface at least embodying herein shield-positioner means for positioning and retaining the braided shield within at least one cutting area of such cutting means during such cutting) positions braided shield jacket 105 between the two cutting blades and outer surface 148 during the cut. Because inner conductors 107 are protectively contained within mandrel 132, the user is free to manipulate wire stripper 102, as needed, to complete the cut. This may include applying a small rotation to wire stripper 102 during the cutting procedure, applying various levels of manual pressure to the circular anvil-cutter 162, etc.

FIG. 11 shows a fourth diagrammatic side view, illustrating cutting die set 116 moved to the open (non-cutting) configuration 142 enabling the separation of the end portion of shielded wire 103 from mandrel 132 and removal of a cut end segment 111 braided shield jacket 105. In this final step, the user releases handgrips 136 to lift arcuate-shaped blade edges 160 of cutting die half-portions 128 away from outer surface 148 of mandrel 132. The cut end segment 111 of braided shield jacket 105 can then be removed from the apparatus and disposed of. Inner conductors 107 are then be removed from inside mandrel 132, allowing them to be installed within the destination component.

FIG. 12 shows a perspective view, exploded for clarity, illustrating components of movable armature 110, cutting die half-portion 128, and manually-operated quick-release feature 166 of cutting assembly 106, according to the preferred embodiment of FIG. 1. Each movable armature 110 preferably comprises a releasable blade retainer 168 configured to removably retain cutting die half-portion 128, as shown in, for example, FIG. 1 (at least herein embodying wherein such cutter-positioner means comprises cutter retainer means for removably retaining such cutting means thereon). Releasable blade retainer 168 further comprises a preferred quick-release feature 166 configured to assist the quick release of cutting die half-portion 128 from armature 110 without the use of tools. This preferred feature enables cutting die half-portion 128 of various size configurations to be interchanged, thereby accommodating shielded wire of differing sizes. Preferably, cutting die set 116 can be size and shape adapted for specific types of multiple shielded inner wire constructions including those identified herein. Upon reading the teachings of this specification, those with ordinary skill in the art will now understand that, under appropriate circumstances, considering issues such as intended use, new and emerging wire design, etc., other cutting arrangements, such as, for example, non-circular blades, multiple blades, blades/dies comprising other regular polygonal shapes, wire-specific blade/die shapes, etc., may suffice.

In reference to FIG. 12, releasable blade retainer 168 preferably comprises an edge slot 127 formed within the edge of cutting die half-portion 128 and a set of complementary recessed receiving slots 170 formed within the distal sides of armature 110, as shown. Cutting die half portion 128 is preferably mounted on armature 110 by sliding engagement of edge slot 127 within receiving slots 170. In the preferred embodiment of the present invention, edge slot 127 of cutting die half-portion 128 is located opposite the cutting blade 158.

Cutting die half portion 128 is securely retained on armature 110 by the manually-operated quick-release feature 166. Quick-release feature 166 is preferably enabled by a spring-loaded bar 172 configured to engage a recessed slot 174 located within the rear face 176 of cutting die half-portion 128. Spring-loaded bar 172 preferably translates along a guide bar 179 located within slot 178 of armature 110, as shown. To lock cutting die half-portion 118 on armature 110, spring-loaded bar 172 is preferably engaged within recessed slot 174. Preferred spring 180 is preferably configured to bias spring-loaded bar 172 toward recessed slot 174. To release cutting die half-portion 118 from armature 110, spring-loaded bar 172 is manually retracted from recessed slot 174. Thus allowing cutting die half-portion 128 to slide out of receiving slots 170 and free of armature 110. Upon reading the teachings of this specification, those with ordinary skill in the art will now understand that, under appropriate circumstances, considering issues such as cost, user preference, etc., other die-mounting arrangements, such as, for example, threaded fasteners, friction engagements, retaining clips, integral (non-removable) mountings, etc., may suffice.

FIG. 13 shows a diagrammatic sectional view, through the section 13-13 of FIG. 1, illustrating preferred internal arrangements of wire stripper 102, according to the preferred embodiment of FIG. 1. Preferably, mandrel 132 is removably coupled with support frame 134. This preferred feature enables mandrels of various diameters to be interchanged to accommodate shielded wire of differing size configurations. Preferably, mandrel 132 is configured to be removably coupled with support frame 134 using at least one quick-change assembly 182 to assist manual quick release of mandrel 132 without the use of tools (at least herein embodying wherein such interposer means comprises releasable coupler means for releasably coupling such interposer means with such supportive coupling means; and, at least herein embodying wherein such at least one support frame further comprises at least one mandrel coupler structured and arranged to releasably couple such at least one mandrel thereon; and, at least herein embodying wherein such at least one mandrel coupler comprises at least one quick-release coupler structured and arranged to assist manual quick release of such at least one mandrel coupler without the use of tools). Quick-change assembly 182 preferably comprises male coupling member 184 joined with mandrel 132 and female coupling member 186 joined with support frame 134, as shown.

FIG. 14 shows a perspective view, illustrating the removable mandrel 132 separated from support frame 134, as described above. Male coupling member 184 preferably comprises a cylindrical nipple having a circumferential groove 164 for receiving a captured ball 191 of female coupling member 186, as shown. Referring again to the sectional view of FIG. 13, female coupling member 186 preferably comprises captured ball 191 and spring-biased locking sleeve 188, which must be axially moved relative to the male member to release captured ball 191 from circumferential groove 164 to disengage the members. Upon reading the teachings of this specification, those with ordinary skill in the art will now understand that, under appropriate circumstances, considering issues such as cost, user preference, intended use, etc., other mandrel-mounting arrangements, such as, for example, thread-on couplers, friction engagements, retainer clips, integral (non-removable) mountings, etc., may suffice.

Preferably, the inner surfaces of handgrips 136 and outer surfaces of support frame 134 comprise sets of projecting bosses 146 on which a pair of biasing springs 144 are engaged, as shown. Biasing springs 144 preferably function to bias wire stripper 102 toward the open (non-cutting) configuration 142 of FIG. 1.

In addition, wire stripper 102 preferably comprises a length gauge 193 (at least embodying herein at least one cut-length setter structured and arranged to assist setting a cut length of such at least one segment of the braided shield) is provided in the form of the about-described impingement rod 190 inserted from the back of the device through hollow bore 155 of mandrel 132. Preferably, impingement rod 190 is adjustably positioned within hollow bore 155. When inserting inner conductors 107 into mandrel 132, impingement rod 190 selectively limits the length of the conductor that can be inserted into hollow bore 155, thus setting the length of the end segment 111 to be cut (at least herein embodying wherein such at least one impingement rod controls the length of the at least one inner conductor that can be inserted within such at least one hollow interior portion by impingement with the at least one inner conductor).

Preferably, support frame 134 of wire stripper 102 comprises threaded end 192, as shown. Preferably, threaded end 192 is coaxial with longitudinal axis 141 and is adapted to receive threaded collet nut 194, as shown. Collet nut 194 is preferably adapted to adjustably retain impingement rod 190 at a selected position within hollow bore 155. Preferably, tightening of collet nut 194 on threaded end 192 at least herein embodying wherein such at least one support frame comprises at least one threaded end adapted to threadably receive such at least one collet nut) compresses an internal collet sleeve 196 against impingement rod 190 thereby restraining rod movement relative to support frame 134. Upon reading the teachings of this specification, those with ordinary skill in the art will now understand that, under appropriate circumstances, considering issues such as cost, etc., other rod restraining arrangements, such as, for example, cam-based clamping devices, externally threaded rods, friction systems, etc., may suffice.

FIG. 15 shows a side view, in partial section, further illustrating the above-described components of length gauge 193, according to the preferred embodiment of FIG. 1. In addition, FIG. 15 shows a preferred rotation coordinator 200 structured and arranged to coordinate the cotemporaneous rotation of movable armatures 110 between open (non-cutting) configuration 142 and closed (cutting) configuration 156 enabling material between the cutting blades and outer surface 148 to be cut. Rotation coordinator 200 preferably comprises a set of intermeshing gear surfaces 202 integrally formed within the handgrips 136, as shown. The preferred action of rotation coordinator 200 (at least embodying herein at least one rotation coordinator structured and arranged to coordinate a cotemporaneous rotation of such at least two movable armatures between at least one non-cutting position and such at least one cutting position enabling material between such at least two cutting blades and such at least one outer surface to be cut) assures that both cutting die half-portions 128 move in concert, thereby engaging the arcuate-shaped blade edges 160 on outer surface 148 of mandrel 132 at the same time and with substantially equal pressure.

FIG. 16 shows a perspective view, exploded for clarity, illustrating components of wire stripper 102, according to the preferred embodiment of FIG. 1. The above-described components are preferably constructed of a rigid and durable material, more preferably at least one metal, most preferably combinations of aluminum and steel. For durability, mandrel 132 and metal die 130 are preferably constructed from steel.

Handgrips 136 are preferably constructed from at least one rigid material, more preferably at least one plastic, most preferably a rigid injection-molded plastic. Upon reading the teachings of this specification, those with ordinary skill in the art will now understand that, under appropriate circumstances, considering issues such as cost, etc., other material selections, such as, for example, rigid plastics, metals, ceramics, epoxies, composites, etc., may suffice.

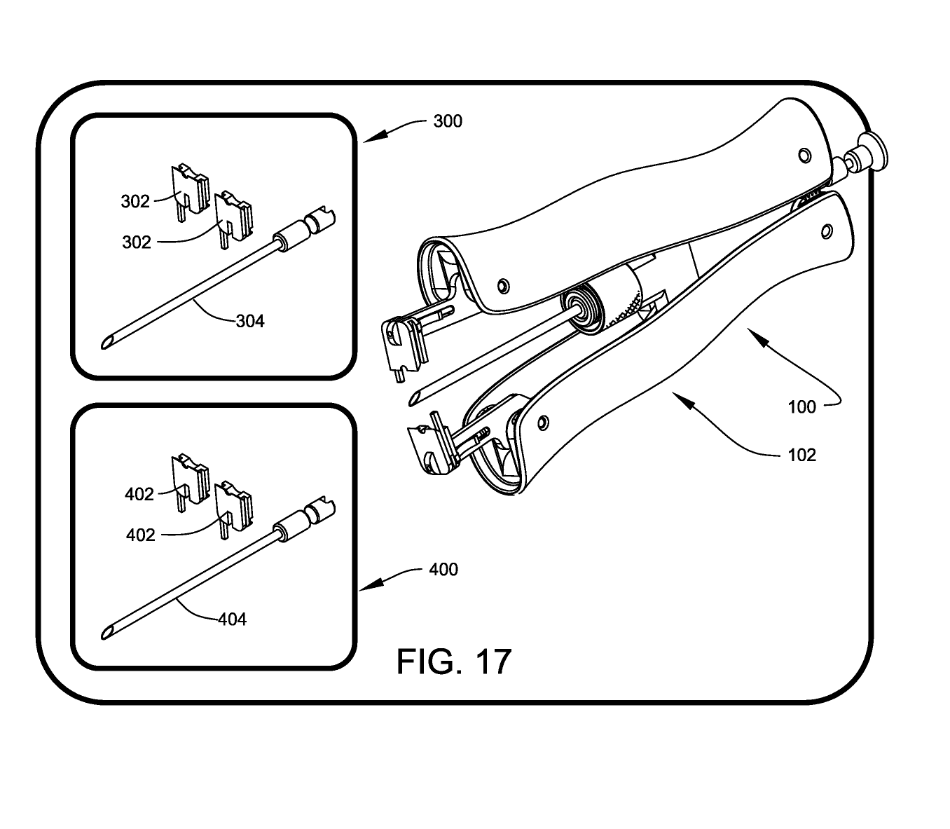

FIG. 17 shows a diagram illustrating interchangeable components of wire stripper 102, according to the preferred embodiment of FIG. 1. Wire stripper 102 is preferably configured to enable the cutting of variously-sized braided shields of variously-sized shielded wires, while protecting inner conductors 107 of the variously-sized shielded wires from scoring and cutting. FIG. 17 shows a first die-mandrel kit 300 comprising two first-sized cutting blades 302 and matching first-size mandrel 304. First-size cutting blades 302 are preferably adapted to circumferentially cut off a first-size segment of a first size braided shield. Similarly, first-size mandrel 304 is preferably designed to interpose between the first-size braided shield and first-size inner conductors of the first-size braided shield.

FIG. 17 further depicts a second die-mandrel kit 400 comprising two second-sized cutting blades 402 and matching second-size mandrel 404. Second-size cutting blades 402 are preferably adapted to circumferentially cut off a second-size segment of a second-size braided shield. Similarly, second-size mandrel 404 is preferably designed to interpose between the second-size braided shield and second-size inner conductors of the second-size braided shield.

Preferably, the physical arrangements of the components of first die-mandrel kit 300 and second die-mandrel kit 400 are as described in the above teachings. Preferably, wire stripper 102 is configured to interchangeably utilize the components of either first die-mandrel kit 300 or second die-mandrel kit 400.

Thus, as illustrated in FIG. 17, there is provided another preferred embodiment of wire stripper system 100, relating to cutting segments of variously-sized braided shields in variously-sized shielded wires, while protecting inner conductors 107 of the variously-sized shielded wires 103 from scoring and cutting, such preferred embodiment comprising at least two first-sized cutting blades structured and arranged to circumferentially cut off at least one first-size segment of a first-size braided shield; at least one first-size mandrel structured and arranged to interpose between the first-size braided shield and first-size inner conductors of the first-size braided shield; at least two second-sized cutting blades structured and arranged to circumferentially cut off at least one second-size segment of a second-size braided shield; at least one second-size mandrel structured and arranged to interpose between the second-size braided shield and the second-size inner conductors of the second-size braided shield; wherein such at least one first-size mandrel comprises at least one first-size outer surface having a first-size outer perimeter and at least one first-size inner surface having a first-size inner cross-sectional area; wherein such first-size inner cross-sectional area of such first-size at least one inner surface comprises a first-size sufficient to contain the at least one first-size inner conductor; wherein such at least two first-size cutting blades comprise a first-size blade edge substantially matching such first-size outer perimeter of such at least one first-size outer surface; wherein such at least two first-size cutting blades and such at least one first-size outer surface comprise at least one first-size circular anvil-cutter structured and arranged to cut material between such at least two first-size cutting blades and such at least one first-size outer surface; wherein such at least one first-size inner surface prevents the at least one first-size inner conductor from positioning between such at least two first-size cutting blades and such at least one first-size outer surface while such at least one first-size outer surface positions the first-size braided shield between such at least two first-size cutting blades and such at least one first-size outer surface; wherein such at least one second-size mandrel comprises at least one second-size outer surface having a second-size outer perimeter and at least one second-size inner surface having a second-size inner cross-sectional area; wherein such second-size inner cross-sectional area of such second-size at least one inner surface comprises a first-size sufficient to contain the at least one second-size inner conductor; wherein such at least two second-size cutting blades comprise a second-size blade edge substantially matching such second-size outer perimeter of such at least one second-size outer surface; wherein such at least two second-size cutting blades and such at least one second-size outer surface comprise at least one second-size circular anvil-cutter structured and arranged to cut material between such at least two second-size cutting blades and such at least one second-size outer surface; wherein such at least one second-size inner surface prevents the at least one second-size inner conductor from positioning between such at least two second-size cutting blades and such at least one second-size outer surface while such at least one second-size outer surface positions the second-size braided shield between such at least two second-size cutting blades and such at least one second-size outer surface; and at least one wire stripper device structured and arranged to interchangeably utilize such at least one first-size mandrel, such at least one second-size mandrel, such at least two first-size cutting blades, and such at least two second-size cutting blades.

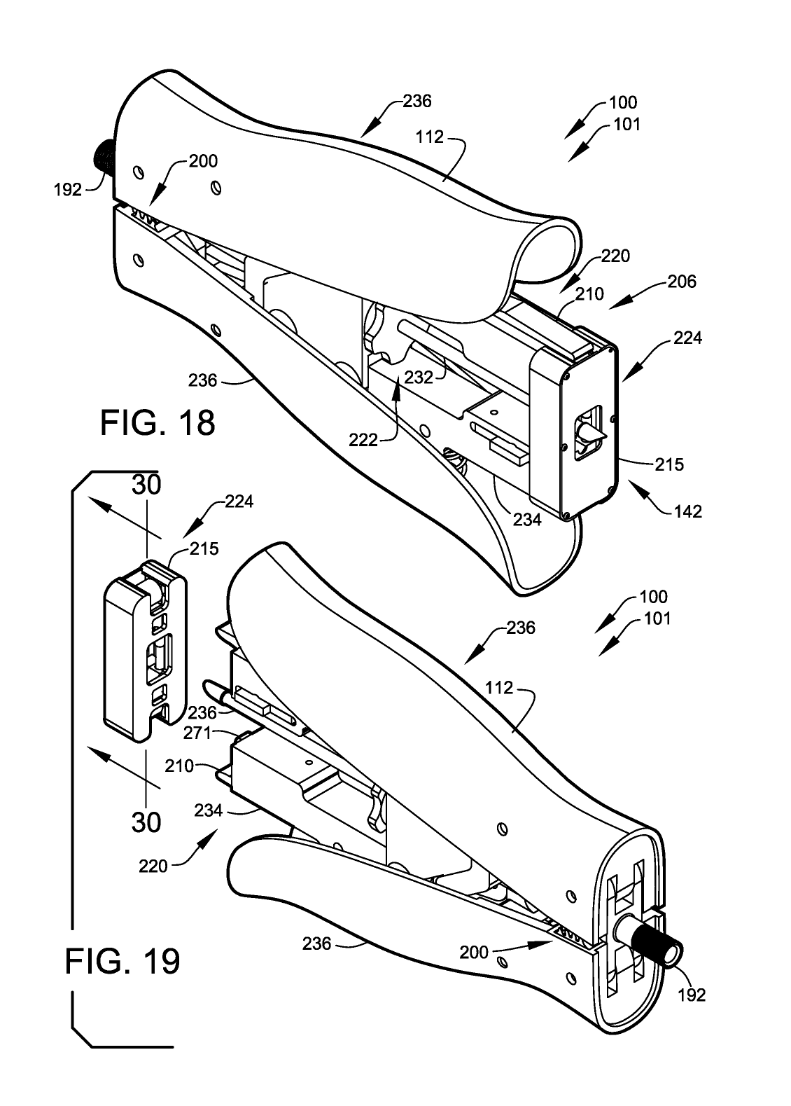

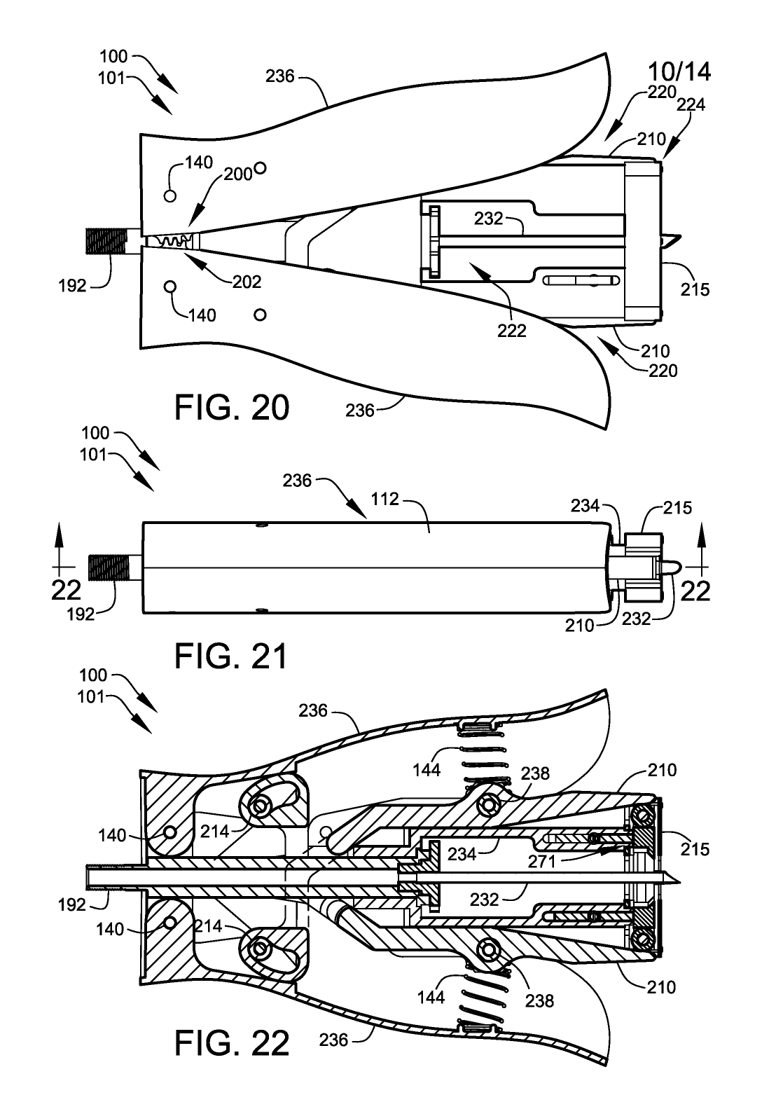

FIG. 18 shows a perspective view, illustrating another improved wire stripper 101, according to another preferred embodiment of the present invention. FIG. 19 shows a perspective view, partially exploded for clarity, illustrating a die cartridge of the wire stripper, according to the preferred embodiment of FIG. 18. FIG. 20 shows a side view, illustrating the wire stripper, according to the preferred embodiment of FIG. 18. FIG. 21 shows a top view, illustrating the wire stripper, according to the preferred embodiment of FIG. 18. Although many of the features of wire stripper 101 are repeated from wire stripper 102, the following discussion primarily will highlight the variations of wire stripper 101, particularly in armature assembly 120, mandrel assembly 122 and die assembly 124 and the various effects transferred to other portions of wire stripper 101 as a result (i.e. attachment points of the handles, etc.).

Wire stripper 101 preferably comprises inner cutting assembly 206 and handgrips 236 which correspond directly with inner cutting assembly 106 and handgrips 136 of wire stripper 102. Inner cutting assembly 206 preferably comprises at least one armature assembly 220, at least one mandrel assembly 222, at least one die assembly 224 and at least one central support frame 234 which correspond directly with armature assembly 120, mandrel assembly 122, die assembly 124 and central support frame 134. Armature assembly 220 preferably comprises at least one armature 210, preferably at least two armatures 210. Mandrel assembly 222 preferably comprises at least one mandrel 232. Die assembly 224 preferably comprises at least one die cartridge 215.

For simplification of illustration impingement rod 190 is not shown along with many of the associated components therewith as it is the same as in wire stripper 102. Further, handgrips 236, like handgrips 136 also preferably comprise rotation coordinator 200 and gripping surfaces 112, as shown. The primary difference of handgrip 236 from handgrip 136 lies in the connections to armature assembly 220. Likewise, central support frame 234 is adapted to the alterations in armature assembly 220, mandrel assembly 222 and die assembly 224 from armature assembly 120, mandrel assembly 122, and die assembly 124. Central support frame 234 coordinates the geometrical positioning of armature assembly 220, mandrel assembly 222 as well as die assembly 224.

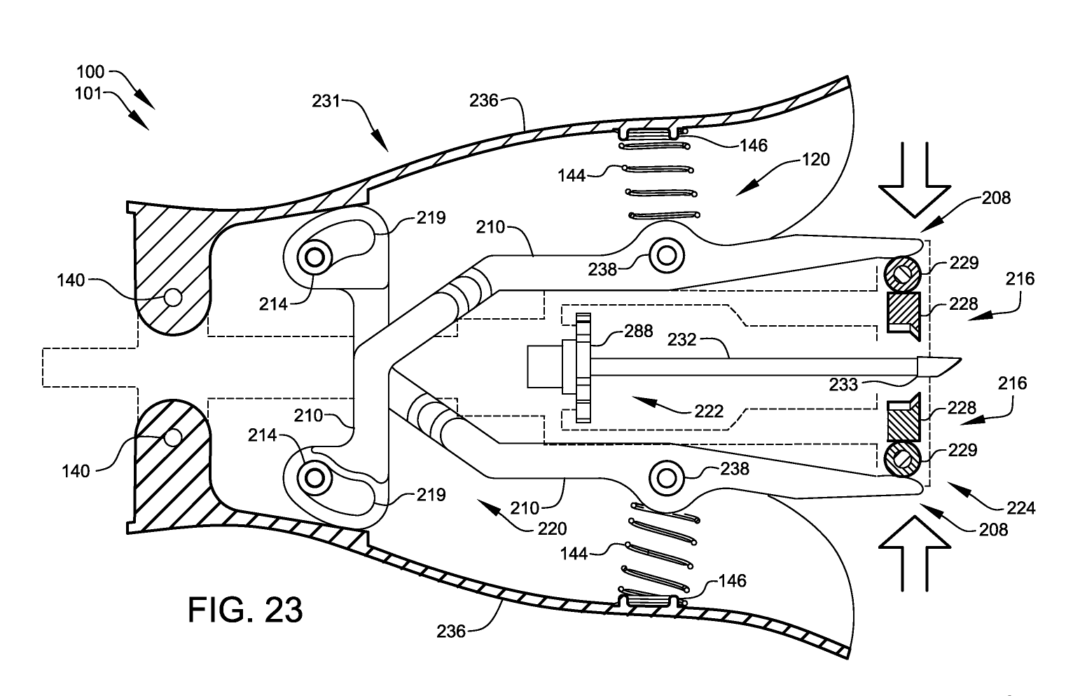

FIG. 22 shows a diagrammatic sectional view, through the section 22-22 of FIG. 21, illustrating the wire stripper, according to the preferred embodiment of FIG. 18. FIG. 23 shows a cutaway view, illustrating armature motion of the wire stripper, according to the preferred embodiment of FIG. 18.

Preferably, the inner surfaces of handgrips 236 and outer surfaces of central support frame 234 comprise sets of projecting bosses 246 on which a pair of biasing springs 144 are engaged, as shown (see also FIG. 24). Biasing springs 144 preferably function to bias wire stripper 101 toward the open (non-cutting) configuration 142. Armatures 210 preferably actuate the compressing of cutting die half-portions 228 together to affect the cutting of braided shield jacket 105, as shown.

Armature 210 preferably comprises a modified scissor-type leverage 231, as shown. Each armature 210 is preferably pivotably coupled to central support frame 234 at forward armature pivot 238, as shown. Likewise, each armature 210 is translationally and pivotably coupled to handgrip 236 at rear armature pivots 214, as shown. Preferably, each armature 210 couples with the handgrip 236 opposite the forward armature pivot 238 with which it couples to central support frame 234, as shown. Thereby, each armature 210 crosses to the side of central support frame 234 (and each other) in a scissor-like fashion. However, each armature 210 pivots around forward armature pivot 238 as handgrips 236 are pressed together, as shown, instead of at the crossing point between them as scissors do. Due to the scissor-like movement, rear armature pivot 214 couple in translational-pivoting coupling 219 on armature 210, as shown. Translational-pivoting coupling 219 comprises at least one arcuate slot preferably to permit rear armature pivot 214 to translationally slide as handgrips 236 are compressed. Translational-pivoting coupling 219 preferably keeps the double-lever action of handgrip 236 and armature 210 from binding.

Modified scissor-type leverage 231 preferably amplifies the force applied of a user's hand upon handgrips 236 through mechanical advantage to a higher force applied to cutting die set 216. The length of the lever arm from rear handgrip pivot 140 to rear armature pivot 214 is preferably shorter than the lever arm of handgrips 236 from where a user applies force and rear handgrip pivot 140, preferably less than half the length of handgrip 236. Further, the lever arm from forward armature pivot 238 to rear armature pivot 214 preferably is at least as long as the lever arm from forward armature pivot 238 to cutting die set 216 at distal end 208 of armature 210, preferably longer.

Mandrel 232 preferably comprises an elongated cylindrical tube having an outer surface 148 with an outer perimeter 150 and a hollow inner bore 155 having an inner surface 152 and inner cross-sectional area 154. The end termination of mandrel 232 preferably comprises a point bevel 117 having an angle of about 45°, as shown. Mandrel 232 is preferably constructed from at least one rigid material with a single rigid metallic material being most preferred.

Mandrel 232 and mandrel 132 comprise many of the same features, however, the end of mandrel 232 preferably further comprises at least one ridge 233. Ridge 233 preferably aligns with cutting die set 216 to provide a shearing edge with which to cut braided shield jacket 105. Ridge 233 preferably further provides at least one snagging edge to assist keeping the cut portion of braided shield jacket on mandrel 232 preferably preventing dropping into the working area (i.e. in the avionics of the aircraft).

In addition, mandrel 232 preferably comprises quick change assembly 282 rather than quick change assembly 182 of wire stripper 102. Quick change assembly 282 preferably comprises a rotational release mechanism, preferably at least one threaded coupler 286. Threaded coupler 286 preferably comprises at least one hand actuator, preferably at least one hand-nut 288, as shown. User preferably may unscrew or tighten, by hand, mandrel assembly 222 on central support frame 234.

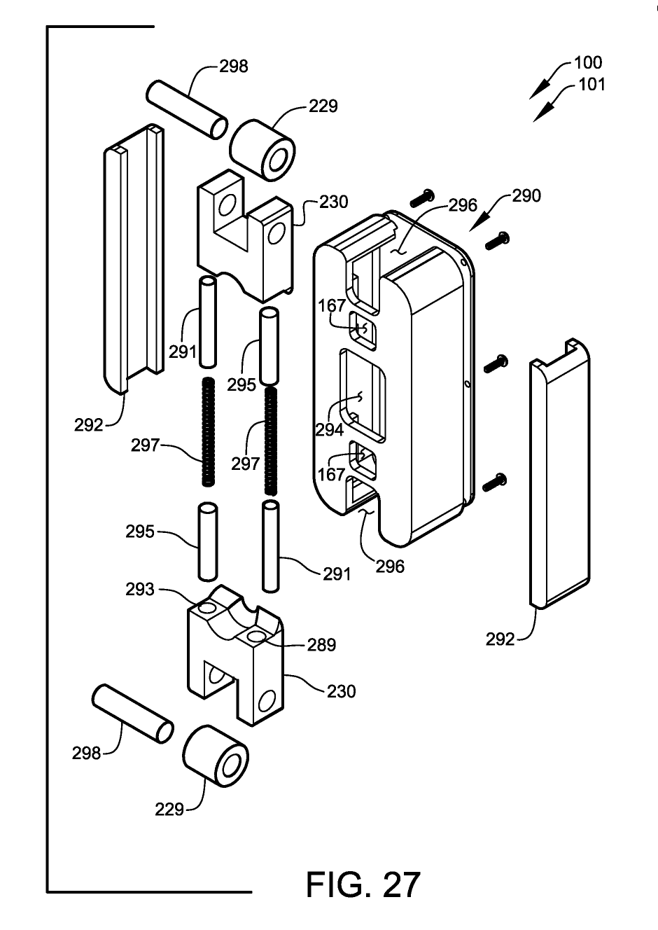

Distal end 208 preferably compresses upon at least one die baring 229 of at least one cutting die half-portion 228, as shown (see also FIG. 27), when handgrips are compressed by the user. Each cutting die half-portion 228

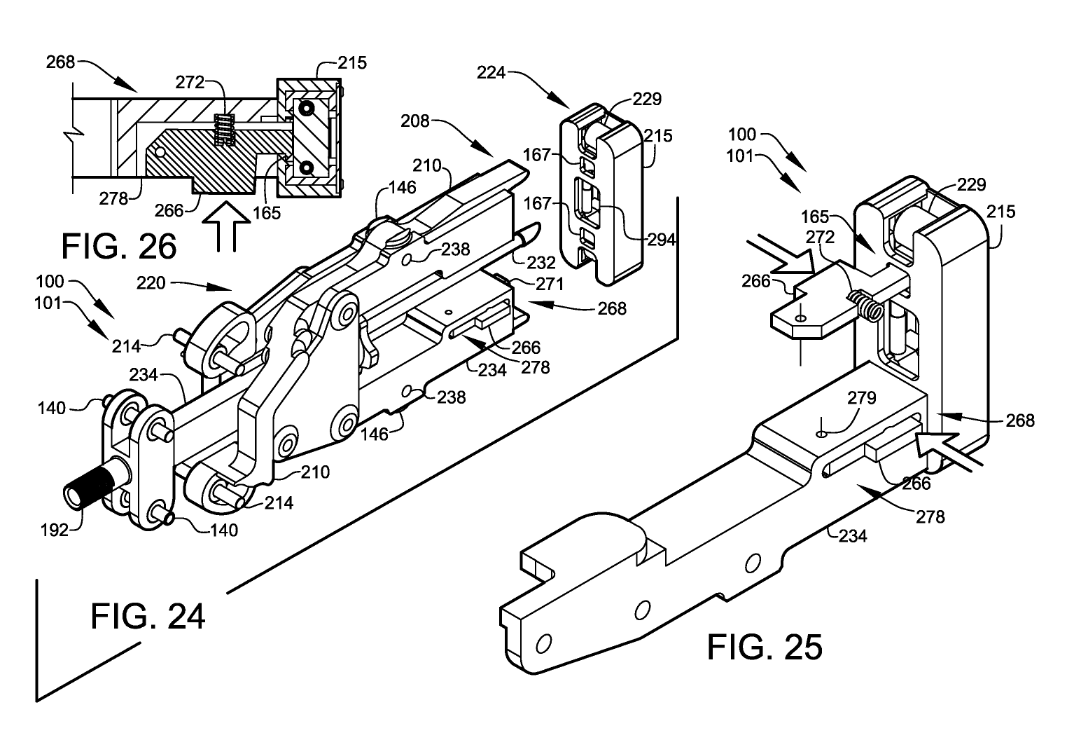

FIG. 24 shows a partial-exploded perspective view, illustrating inner cutting assembly 206 of wire stripper 101, according to the preferred embodiment of FIG. 18. FIG. 25 shows a detail perspective view, illustrating a quick release 268 of wire stripper 101, according to the preferred embodiment of FIG. 18. FIG. 26 shows a cross-sectional detail view, illustrating quick release 268 of wire stripper 101, according to the preferred embodiment of FIG. 18. Inner cutting assembly 206 further comprises at least one quick release 268 structured to couple and release die assembly 224 from central support frame 234, as shown.

Quick release 268 preferably comprises at least one release actuator 266 in at least one actuator slot 278. Release actuator 266 preferably comprises at least one pivot cam, as shown. Release actuator 266 preferably is pivotably coupled inside actuator slot 278 with release pivot 279. Release actuator preferably comprises at least one cartridge catch 165 structured to catch on die cartridge 215. Quick release preferably further comprises at least one biasing spring 272 structured to bias cartridge catch 165 into a “locked” position, as shown.

Central support frame 234 preferably comprises quick release 268, preferably at least two quick releases 268. Quick release preferably further comprises at least one cartridge catch hole 167 on die cartridge 215. When attaching die cartridge 215, cartridge catch 165 preferably slides to one side as entering cartridge catch hole 167. Once fully inside cartridge catch hole 167, cartridge catch 165 returns to its original position (through influence of biasing spring 272) and catches on the edge of cartridge catch hole 167. When de-coupling die cartridge 215, release actuator 266 is pressed inward moving cartridge catch 165 to an “unlocked” position and permitting the removal of die cartridge 215. Central support frame preferably further comprises at least one cartridge aligner 271 (see FIGS. 19 and 22) structured to align die cartridge 215 when coupled to central support frame 234. Cartridge aligner 271 preferably fits both the width and the height of cartridge catch hole 167 and preferably surrounds cartridge catch 165 on two sides (the third and fourth permitting cartridge catch 165 movement to latch onto the edge of cartridge catch hole 167). Die cartridge 215 preferably can be attached to central support frame 234 in either direction (having 180 degree rotation symmetry).

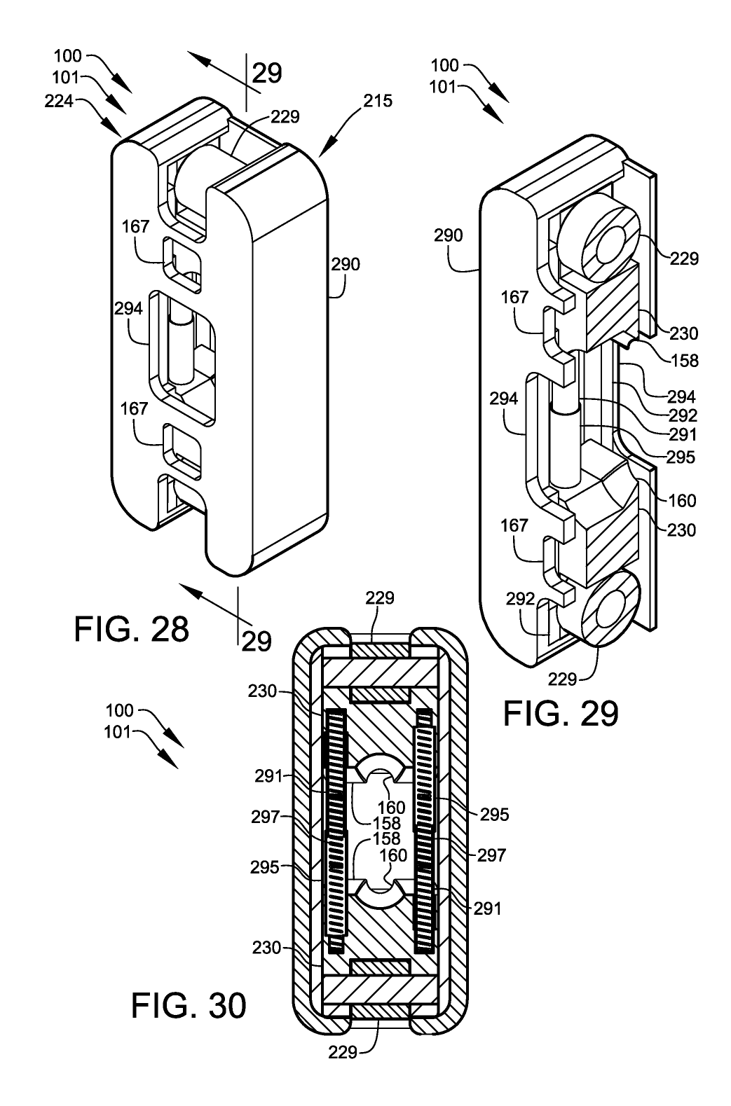

FIG. 27 shows an exploded perspective view, illustrating die cartridge 215 of wire stripper 101, according to the preferred embodiment of FIG. 18. FIG. 28 shows a perspective view, illustrating die cartridge 215 of wire stripper 101, according to the preferred embodiment of FIG. 18. FIG. 29 shows a diagrammatic sectional view, through the section 29-29 of FIG. 28, illustrating die cartridge 215 of wire stripper 101, according to the preferred embodiment of FIG. 18. FIG. 30 shows a diagrammatic sectional view, through the section 30-30 of FIG. 19, illustrating die cartridge 215 of wire stripper 101, according to the preferred embodiment of FIG. 18. Die cartridge 215 preferably comprises cutting die set 216 disposed within at least one housing 290. Cutting die set preferably comprises two cutting die half-portions 228. Each cutting die half-portion 228 preferably comprises at least one metal die 230 and die baring 229. Die baring 229 preferably couples with metal die 230 with at least one baring pin 298, as shown. Each cutting die half-portion 228 preferably rides on at least one die rail 292, preferably two die rails 292 (oppositely disposed), as shown. Die rail 292 preferably keep cutting die set 216 aligned for optimal cutting and permits a linear movement of each cutting die half-portion 228 during the cutting process. Each cutting die half-portion 228 is biased away from the center of die cartridge 215 by at least one biasing spring 297, preferably at least two biasing springs 297. Biasing springs 297 preferably are disposed to each side of cutting die half-portion 228 to permit clearance for shielded wire 103 to be inserted. Biasing spring 297 preferably inserts into at least one spring guide 295 and at least one spring guide 291. Spring guide 291 preferably inserts into guide hole 289 in metal die 230. Spring guide 295 preferably inserts into guide hole 293 in metal die 230. Spring guide 291 preferably inserts into spring guide 295 creating a shock-like structure with biasing spring 297. Cutting die half portions 228 are rotationally symmetrical.

Die rails 292, cutting die half-portions 228, spring guides 295, spring guides 291 and biasing springs 297 are assembled within housing 290. Housing 290 preferably comprises at least one armature opening 296, preferably structured to permit armature 210 to compress cutting die half-portion 228 through contact with die baring 229 toward the center of die cartridge 215. Housing 290 preferably further comprises cartridge catch hole 167. Housing preferably further comprises at least one central opening 294. Central opening 294 preferably permits mandrel 232 to pass through die cartridge 215. Central opening preferably further permits insertion of shielded wire 103 to permit cutting of braided shield jacket 105.

Upon reading the teachings of this specification, those with ordinary skill in the art will now appreciate that combinations of elements from each embodiment are within the scope of this description, and are not intended to be interpreted as mutually exclusive except where a combination of elements conflict in a manner that would render the device inoperable. For example, this specification engenders understanding that would permit one of ordinary skill to make modifications including, for example, the use of mandrel 232 on wire stripper 102, the use of die cartridge 215 on wire stripper 102, the use of quick-change assembly 182 on mandrel 232, etc.

Although applicant has described applicant's preferred embodiments of this invention, it will be understood that the broadest scope of this invention includes modifications such as diverse combinations, shapes, sizes, and materials. Such scope is limited only by the below claims as read in connection with the above specification. Further, many other advantages of applicant's invention will be apparent to those skilled in the art from the above descriptions and the below claims.

What is claimed is:

1) A system, relating to cutting at least one segment of a braided shield in a shielded wire while protecting at least one inner conductor of the shielded wire from scoring and cutting, comprising:
a) at least one cutter structured and arranged to cut the at least one segment of the braided shield in the shielded wire;
b) at least one shield-positioner structured and arranged to position and retain the braided shield within at least one cutting area of said cutter during cutting; and
c) at least one conductor-positioner structured and arranged to position and retain the at least one inner conductor of the shielded wire outside of said at least one cutting area of said cutter during cutting;
d) wherein said at least one shield-positioner and said at least one conductor-positioner comprise at least one interposer structured and arranged to interpose between the braided shield and the at least one inner conductor; and
e) wherein, during cutting of the braided shield, the at least one inner conductor of the shielded wire is protected by said interposer from scoring and cutting by said cutter.

2) The system according to claim 1 further comprising at least one actuator structured and arranged to actuate said at least one cutter from at least one non-cutting position to at least one cutting position.

3) The system according to claim 2 wherein said at least one interposer comprises at least one releasable coupler structured and arranged to releasably couple said at least one interposer with said system.

4) The system according to claim 2 wherein said at least one cutter comprises at least one releasable coupler structured and arranged to releasably couple said at least one cutter with said system.

5) The system according to claim 2 Further comprising:
a) at least one cut-length setter structured and arranged to set a cut length of said at least one segment of the braided shield;
b) wherein said at least one cut-length setter comprises
i) at least one impingement rod adjustably positioned within said at least one conductor-positioner, and
ii) at least one collet nut adapted to adjustably retain said at least one impingement rod at a selected position within said at least one conductor-positioner; and
c) wherein said at least one impingement rod controls the length of the at least one inner conductor that can be inserted within said at least one conductor-positioner by impingement with the at least one inner conductor.

6) The system according to claim 2 wherein said at least one cutting comprises
a) at least two cutting blades;
b) at least one blade guide structured and arranged to guide said at least two blades from at least one open position to at least one cutting position;
c) at least one actuator engager structured and arranged to engage said at least one actuator and said at least two cutting blades;
d) at least one cutter enclosure structured and arranged to enclose said at least one cutter.

7) The system according to claim 6 wherein said at least one actuator engager comprises at least one bearing.

8) A system, relating to cutting at least one segment of a braided shield in a shielded wire while protecting at least one inner conductor of the shielded wire from scoring and cutting, comprising:
a) at least two cutting blades structured and arranged to circumferentially cut off the at least one segment of the braided shield; and
b) at least one mandrel structured and arranged to interpose between the braided shield and the at least one inner conductor;
c) wherein said at least one mandrel comprises at least one outer surface having an outer perimeter and at least one inner surface having an inner cross-sectional area;
d) wherein said inner cross-sectional area of said at least one inner surface comprises a size sufficient to contain the at least one inner conductor;
e) wherein said at least two cutting blades comprise a blade edge substantially matching said outer perimeter of said at least one outer surface;
f) wherein said at least two cutting blades and said at least one outer surface comprise at least one circular cutter structured and arranged to cut material between said at least two cutting blades and said at least one outer surface; and
g) wherein said at least one inner surface prevents the at least one inner conductor from positioning between said at least two cutting blades and said at least one outer surface while said at least one outer surface positions the braided shield between said at least two cutting blades and said at least one outer surface.

9) The system according to claim 8 further comprising
a) at least two movable armatures each one structured and arranged to moveably actuate at least one cutting blade of said at least two cutting blades;
b) wherein said at least two movable armatures are configured to assist in moving said at least two cutting blades from at least one non-cutting position to at least one cutting position enabling cutting of the material located between said at least two cutting blades and said at least one outer surface.

10) The system according to claim 9 wherein each one of said at least two movable armatures comprise at least one blade engager structured and arranged to removably engage said at least one cutting blade thereon.

11) The system according to claim 10 wherein said blade engager comprises at least one quick-release assembly structured and arranged to assist manual quick release of said at least one cutting blade without the use of tools.

12) The system according to claim 9 further comprising at least one support frame structured and arranged to at least support said at least two movable armatures and said at least one mandrel.

13) The system according to claim 9 further comprising at least one manual actuator structured and arranged to assist manual actuation of said at least two movable armatures by hand.

14) The system according to claim 13 wherein said at least one manual actuator comprises at least one hand grip structured and arranged to assist hand gripping of said at least one manual actuator.

15) The system according to claim 14 wherein:
a) each said at least two movable armatures comprises at least one pivot axis about which a respective one of said at least two movable armatures rotate; and
b) at least one rotation coordinator structured and arranged to coordinate a cotemporaneous rotation of said at least two movable armatures between at least one non-cutting position and said at least one cutting position enabling material between said at least two cutting blades and said at least one outer surface to be cut.

16) The system according to claim 15 wherein said at least one support frame further comprises at least one mandrel coupler structured and arranged to releasably couple said at least one mandrel thereon.

17) The system according to claim 16 wherein said at least one mandrel coupler comprises at least one quick-release coupler structured and arranged to assist manual quick release of said at least one mandrel coupler without the use of tools.

18) The system according to claim 8 wherein:
a) said at least one mandrel comprises at least one tubular member comprising at least one hollow interior portion; and
b) said at least one hollow interior portion is adapted to accommodate the at least one inner conductor of the shielded wire.

19) The system according to claim 19 Further comprising:
a) at least one cut-length setter structured and arranged to assist setting a cut length of said at least one segment of the braided shield;
b) wherein said at least one cut-length setter comprises
i) at least one impingement rod adjustably positioned within said at least one hollow interior portion, and
ii) at least one collet nut adapted to adjustably retain said at least one impingement rod at a selected position within said at least one hollow interior portion;
c) wherein said at least one support frame comprises at least one threaded end adapted to threadably receive said at least one collet nut; and
d) wherein said at least one impingement rod controls the length of the at least one inner conductor that can be inserted within said at least one hollow interior portion by impingement with the at least one inner conductor.

20) A system, relating to cutting segments of variously-sized braided shields in variously-sized shielded wires while protecting inner conductors of the variously-sized shielded wires from scoring and cutting, said system comprising:
a) at least two first-sized cutting blades structured and arranged to circumferentially cut off at least one first-size segment of a first-size braided shield;
b) at least one first-size mandrel structured and arranged to interpose between the first-size braided shield and first-size inner conductors of the first-size braided shield;
c) at least two second-sized cutting blades structured and arranged to circumferentially cut off at least one second-size segment of a second-size braided shield; and
d) at least one second-size mandrel structured and arranged to interpose between the second-size braided shield and the second-size inner conductors of the second-size braided shield;
e) wherein said at least one first-size mandrel comprises at least one first-size outer surface having a first-size outer perimeter and at least one first-size inner surface having a first-size inner cross-sectional area;
f) wherein said first-size inner cross-sectional area of said first-size at least one inner surface comprises a first-size sufficient to contain the at least one first-size inner conductor;
g) wherein said at least two first-size cutting blades each comprise a first-size blade edge substantially matching said first-size outer perimeter of said at least one first-size outer surface;
h) wherein said at least two first-size cutting blades and said at least one first-size outer surface comprise at least one first-size circular anvil-cutter structured and arranged to cut material between said at least two first-size cutting blades and said at least one first-size outer surface;
i) wherein said at least one first-size inner surface prevents the at least one first-size inner conductor from positioning between said at least two first-size cutting blades and said at least one first-size outer surface while said at least one first-size outer surface positions the first-size braided shield between said at least two first-size cutting blades and said at least one first-size outer surface;
j) wherein said at least one second-size mandrel comprises at least one second-size outer surface having a second-size outer perimeter and at least one second-size inner surface having a second-size inner cross-sectional area;
k) wherein said second-size inner cross-sectional area of said second-size at least one inner surface comprises a second size sufficient to contain the at least one second-size inner conductor;
l) wherein said at least two second-size cutting blades each comprise a second-size blade edge substantially matching said second-size outer perimeter of said at least one second-size outer surface;
m) wherein said at least two second-size cutting blades and said at least one second-size outer surface comprise at least one second-size circular anvil-cutter structured and arranged to cut material between said at least two second-size cutting blades and said at least one second-size outer surface; and
n) wherein said at least one second-size inner surface prevents the at least one second-size inner conductor from positioning between said at least two second-size cutting blades and said at least one second-size outer surface while said at least one second-size outer surface positions the second-size braided shield between said at least two second-size cutting blades and said at least one second-size outer surface; and
o) at least one wire stripper device structured and arranged to interchangeably utilize said at least one first-size mandrel, said at least one second-size mandrel, said at least two first-size cutting blades, and said at least two second-size cutting blades.
